(19) United States
(12) Patent Application Publication
(10) Pub. No.: US 2019/0332355 A1
(43) Pub. Date: Oct. 31, 2019

(54) METHOD AND APPARATUS FOR PRE-ROUNDING IN A MULTIPLIER-ACCUMULATOR

(71) Applicant: Tempo Semiconductor, Inc., Austin, TX (US)

(72) Inventor: Darrell Tinker, Austin, TX (US)

(21) Appl. No.: 15/991,221

(22) Filed: May 29, 2018

Related U.S. Application Data
(60) Provisional application No. 62/662,367, filed on Apr. 25, 2018.

(51) Int. Cl. G06F 7/499; G06F 7/544

(52) U.S. Cl. CPC G06F 7/49947; G06F 7/5443

(57) ABSTRACT

A method and apparatus for use in a multiply-accumulate (“MAC”) facility to pre-round a result.

### BACKGROUND OF THE INVENTION

### 1. Field of the Invention

The present invention relates to a method and apparatus for rounding in a multiplier-accumulator.

### 2. Description of the Related Art

In general, in the descriptions that follow, I will italicize the first occurrence of each special term of art that should be familiar to those skilled in the art of integrated circuits (“ICs”) and systems. In addition, when I first introduce a term that I believe to be new or that I will use in a context that I believe to be new, I will bold the term and provide the definition that I intend to apply to that term. In addition, throughout this description, I will sometimes use the terms assert and negate when referring to the rendering of a signal, signal flag, status bit, or similar apparatus into its logically true or logically false state, respectively, and the term toggle to indicate the logical inversion of a signal from one logical state to the other. Alternatively, I may refer to the mutually exclusive boolean states as logic_0 and logic_1. Of course, as is well known, consistent system operation can be obtained by reversing the logic sense of all such signals, such that signals described herein as logically true become logically false and vice versa. Furthermore, it is of no relevance in such systems which specific voltage levels are selected to represent each of the logic states.

Hereinafter, when I refer to a facility I mean a circuit or an associated set of circuits adapted to perform a particular function regardless of the physical layout of an embodiment thereof. Thus, the electronic elements comprising a given facility may be instantiated in the form of a hard macro adapted to be placed as a physically contiguous module, or in the form of a soft macro the elements of which may be distributed in any appropriate way that meets speed path requirements. In general, electronic systems comprise many different types of facilities, each adapted to perform specific functions in accordance with the intended capabilities of each system. Depending on the intended system application, the several facilities comprising the hardware platform may be integrated onto a single IC, or distributed across multiple ICs. Depending on cost and other known considerations, the electronic components, including the facility-instantiating IC(s), may be embodied in one or more single- or multi-chip packages. However, unless I expressly state to the contrary, I consider the form of instantiation of any facility that practices my invention as being purely a matter of design choice.

Further, when I use the term develop I mean any process or method, whether arithmetic or logical or a combination thereof, for creating, calculating, determining, effecting, producing, instantiating or otherwise bringing into existence a particular result. In particular, I intend this process or method to be instantiated, embodied or practiced by a facility or a particular component thereof or a selected set of components thereof, without regard to whether the embodiment is in the form of hardware, firmware, software or any combination thereof.

Shown in FIG. 1 is a typical general purpose computer system 10. In particular, in recently-developed battery-powered mobile systems, such as smart-phones and the like, many of the discrete components typical of desktop or laptop devices illustrated in FIG. 1 are integrated into a single integrated circuit chip.

Shown by way of example in FIG. 2 is one embodiment of a single-chip audio coder/decoder (“CODEC”) 12 comprising: a plurality of digital modules; and a plurality of analog modules. In this embodiment, CODEC 12 includes a Serial Data Interface facility adapted to send data to, and receive digital data from, the system 10; a Digital Phase-Locked Loop (“DPLL”) facility adapted to determine the timing and rate relationship between two asynchronous data streams; a Configuration Memory and Control facility adapted to control which facilities are used and how, in accordance with configuration and control information received from the system 10; a Digital Signal Processor (“DSP”) facility adapted to perform various data processing activities in accordance with a stored computer program; and a Data Memory facility adapted to store, as required, audio data flowing from the system 10 to the audio output devices. I may expand on the functionality of certain of these facilities as I now explain the method of operation of my invention and embodiments thereof.

As is known, rounding is needed in digital arithmetic units (“AUs”) to preserve the maximum accuracy whenever the number of bits of precision is reduced. The simplest method of rounding is to add a 1 bit to the bit just below the least significant bit (“LSB”) of the rounded result, followed by truncating the lower bits. For example, if a 32-bit fixed-point number represented as 16 integer bits and 16 fraction bits is to be rounded to a 16-bit integer, the fraction ½ would be added to the 32-bit number, and then the result would be truncated to 16 bits, selecting the upper 16 bits and dropping the lower 16 bits. If the bits of the 32-bit number are numbered from 0 to 31, 0 being the LSB and 31 being the most significant bit (“MSB”), adding the fraction ½ is the same as a 1 bit added to bit 15 of the 32-bit number. In this example, at least a 17-bit half-adder would be required to perform the addition prior to the truncation.

One application requiring rounding is in a multiplier-accumulator (“MAC”) unit adapted to perform the following operations:

Multiply:

Accumulator<=Multiplier*Multiplicand [Eq. 1]

Multiply-Accumulate:

Accumulator<=Accumulator+Multiplier*Multiplicand [Eq. 2]

In FIG. 3, I have illustrated a typical prior art MAC unit 14. If the multiplier, B, and the multiplicand, C, are each, say, 24 bits wide, i.e., m=n=24, Multiplier 18, Full-Adder 20, and Accumulator 22 must be at least 48 bits wide to accommodate the full range of results. After performing at least one multiply and 0 or more multiply-accumulates, the result stored in Accumulator 20 may need to be reduced back to 24 bits with shifting and rounding. This would typically be done with a Shifter 24 acting on the value stored in the Accumulator, followed by a Half-Adder 26, wherein the Shifter 24 selects 25 bits, and the Half-Adder 26 adds a 1 to the selected LSB. After the Half-Adder 26, the LSB is truncated, leaving the 24 bit rounded result. All of these operations are selectively sequenced by Control 28.

The following pseudocode illustrates a prior art method of using the MAC 14 of FIG. 3:

| | | |
|---|---|---|
| MULT | FACTOR_1 DATA_1 | // Acc <= FACTOR_1*DATA_1; |

...

| | | |
|---|---|---|
| MAC | FACTOR_N DATA_N | // Acc <= Acc+FACTOR_N*DATA_N; |
| SHIFT | DESTINATION 2 | // DEST <= Truncate((Acc << 2)+0.5); |

In all of the prior art known to me, the MAC unit dedicates a half-adder to rounding, and, for wide data words, a large number of circuits may be required to propagate the carry all the way across the half-adder within the available cycle time. I submit that a method is needed to perform the multiply-accumulate functions more effectively and efficiently than the prior art, and with less circuitry.

### BRIEF SUMMARY OF THE INVENTION

In accordance with a first embodiment of my invention, I provide a rounding method for use in a multiply-accumulate (“MAC”) facility comprising controlling the MAC to perform the steps of: developing a product by multiplying a selected multiplicand by a selected multiplier; developing a rounded product by adding to the product a selected one of a predetermined rounding value and an accumulator value; developing the accumulator value by storing the rounded product; and developing a rounded result by selectively shifting the accumulator value.

In accordance with one other embodiment of my invention, a MAC facility may be adapted to practice my pre-rounding method.

In accordance with yet another embodiment of my invention, a digital signal processing system may comprise a MAC facility adapted to practice my pre-rounding method.

In accordance with still another embodiment of my invention, a non-transitory computer readable medium may include executable instructions which, when executed in a processing system, causes the processing system to perform the steps of my pre-rounding method.

### BRIEF DESCRIPTION OF THE SEVERAL VIEWS OF THE DRAWINGS

My invention may be more fully understood by a description of certain preferred embodiments in conjunction with the attached drawings in which:

FIG. 1 illustrates, in block diagram form, a general purpose computer system adapted to practice my invention;

FIG. 2 illustrates, in block diagram form, a typical integrated system adapted to practice my invention;

FIG. 3 illustrates, in block diagram form, a prior art MAC unit;

FIG. 4 illustrates, in block diagram form, one embodiment of a MAC unit adapted to practice my invention;

FIG. 5 illustrates, in block diagram form, another embodiment of a MAC unit adapted to practice my invention; and

FIG. 6 illustrates, in flow diagram form, one embodiment of my pre-rounding method.

In the drawings, similar elements will be similarly numbered whenever possible. However, this practice is simply for convenience of reference and to avoid unnecessary proliferation of numbers, and is not intended to imply or suggest that my invention requires identity in either function or structure in the several embodiments.

### DETAILED DESCRIPTION OF THE INVENTION

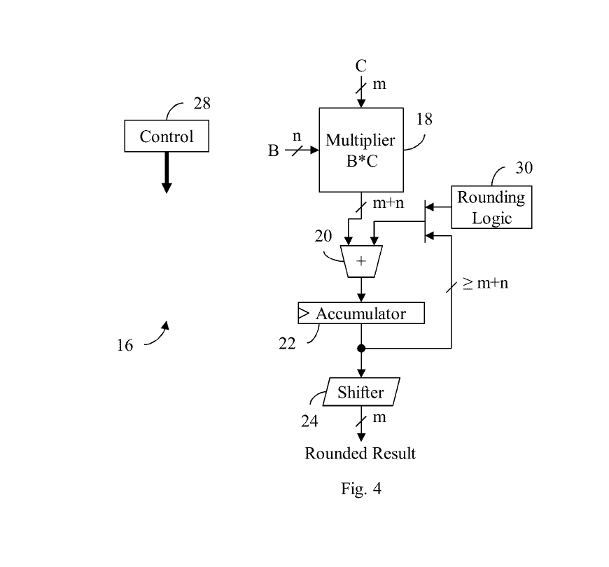

In accordance with my invention, I provide a method and apparatus for pre-rounding in a multiply-accumulate facility. In FIG. 4, I have illustrated a multiply-accumulate facility 16 configured to practice my invention.

I have noticed that the addition of the rounding bit just below the LSB of the desired result does not need to be done after the series of multiplies or multiply-accumulates—it can be done at any time, so long as the bit is added at the correct bit position with respect to the eventual shift or bit selection. Rounding Logic 30 is configured to provide the correct addend to the Full-Adder 20 in response to signals from Control 28.

By way of example, let us assume that the rounding addition is performed during the first multiply cycle, using the Full-Adder 20. Therefore, the Half-Adder 26 in the prior art MAC 14 is no longer needed to perform the rounding, and may be eliminated. All that is required is for Control 28 to select the correct bits of the final result using the Shifter 24, truncating any lower bits, and the rounding is complete. Furthermore, by using the Full-Adder 20, but during the first multiply cycle, no additional cycle time is required for rounding.

The following pseudocode illustrates a method of using the MAC 16 of FIG. 4:

| | | |
|---|---|---|
| MULR2 | FACTOR_1 DATA_1 | // Acc <= FACTOR_1*DATA_1+(0.5 >> 2); |

...

| MAC FACTOR_N DATA_N | | // Acc <= Acc+FACTOR_N*DATA_N; |
|---|---|---|
| SHIFT | DESTINATION 2 | // DEST <= Truncate(Acc << 2); |

In this example, the rounding bit is shifted right 2 bits during the first multiply operation so that it will align in the correct position relative to the LSB after a subsequent 2 bit left shift and truncation of the Accumulator contents.

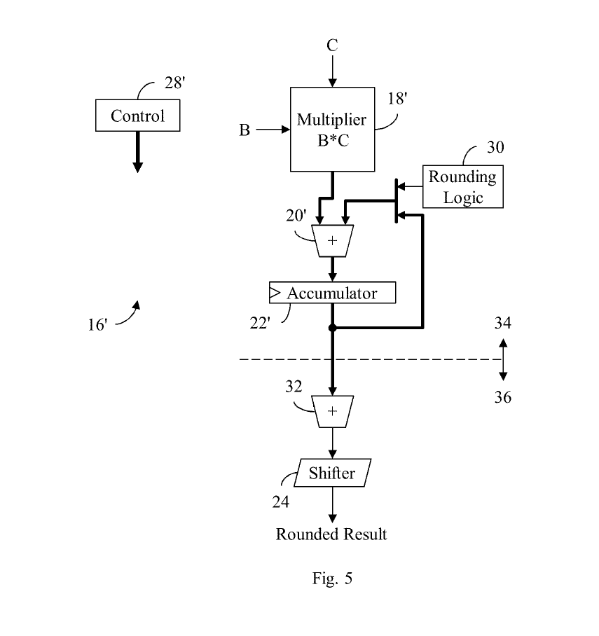

In the embodiment illustrated in FIG. 5, I have configured Multiplier 18′ to develop the product in carry-save format, comprising a sum bit and a carry bit for at least some bit positions. Further, Adder 20′ is configured to develop the rounded product in carry-save format; and Accumulator 22′ is adapted to store the rounded product in carry-save format. The data path from Accumulator 22′ back to Adder 20′ is also in carry-save format. A carry-propagate Adder 32, interposed between the Accumulator 22′ and Shifter 24, converts the carry-save format to carry-propagated format for use by Shifter 24. The embodiment of FIG. 5 is especially configured for implementation in a pipelined MAC 16′, because the carry propagate delays inherent in the carry-propagate Adder 20 (see, FIG. 4) are moved from the multiply-accumulate stage 34 to the shift-truncate stage 36, thus better balancing the signal delays between the two stages, and allowing the MAC 16′ to operate at a higher clock rate.

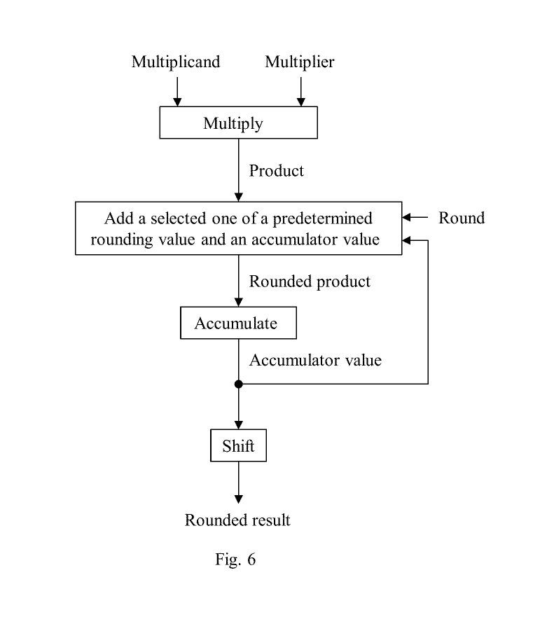

In general, as illustrated in FIG. 6, my method is adapted purposely to use a rounding bit value that does not always match the subsequent shift selection. For example, suppose an algorithm requires multiplying a first number by a selected constant to develop a first product, rounding the first product to develop a first rounded product, multiplying the first rounded product by the selected constant to develop a second product, and then rounding the second product to develop a second rounded product. In accordance with my method, the first product is rounded by adding 1 in the first rounded product LSB position rather than ½. Then the second product is truncated without rounding to develop a second rounded product. The net effect is almost identical to rounding both times using ½ for rounding if the selected constant is near unity and the first number is not small; however, the result is better for some applications that would normally round the first product with 1 and the second product with 0 if the first number is small, because then the second rounded product will always be smaller than the first number if the selected constant is less than 1, and the second rounded product will always be larger than the first number if the selected constant is greater than 1.

One application for this method is a volume control that ramps a volume exponentially up or down with a constant ramp factor. For example, to ramp the volume, V, up by a factor (1+Delta), wherein Delta is small, we would calculate:

V′=(1+Delta)*V=V+Delta*V [Eq. 3]

And to ramp the volume down by a factor (1−Delta) we would calculate:

V′=(1−Delta)*V=V−Delta*V [Eq. 4]

In ordinary rounding, you would add ½ to each of these calculations and then truncate, but if V is less than 1/(2*Delta), then the volume will get stuck, because the change in V before rounding will always be less than ½ the value of the LSB. In accordance with my method, my Rounding Logic 30 would be configured to alternate between providing 1 and 0 for rounding, instead of always providing ½. Then when the rounding value of 1 is used, the value of V will always at least increment by 1 when ramping up, and when the rounding value of 0 is used, the value of V will always at least decrement by 1 when ramping down.

The following pseudocode illustrates this method of using the MAC 16 of FIG. 4:

| | |
|---|---|
| MULR1 RAMP VOLUME | // Acc <= RAMP*VOLUME+(0.5 >> 1); |
| SHIFT VOLUME 2 | // VOLUME <= Truncate(Acc << 2); |

...

| | |
|---|---|
| MULT RAMP VOLUME | // Acc <= RAMP*VOLUME; |
| SHIFT VOLUME 2 | // VOLUME <= Truncate(Acc << 2); |

The round 1 during the first multiply would be normal for a subsequent left shift by 1 bit, but, in this example, the subsequent left shift is by 2 bits. Note that, during the second multiply-and-shift pair, no round bit is added. The volume result after the second multiply-and-shift is guaranteed to have changed from the input volume before the first multiply, even if RAMP is close to 1 and the input volume is close to zero.

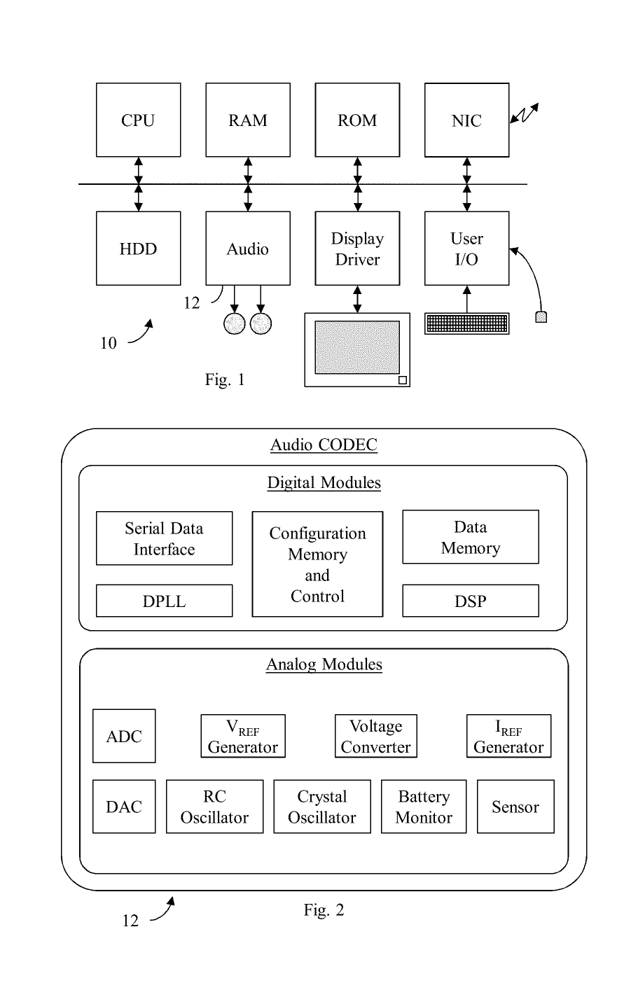

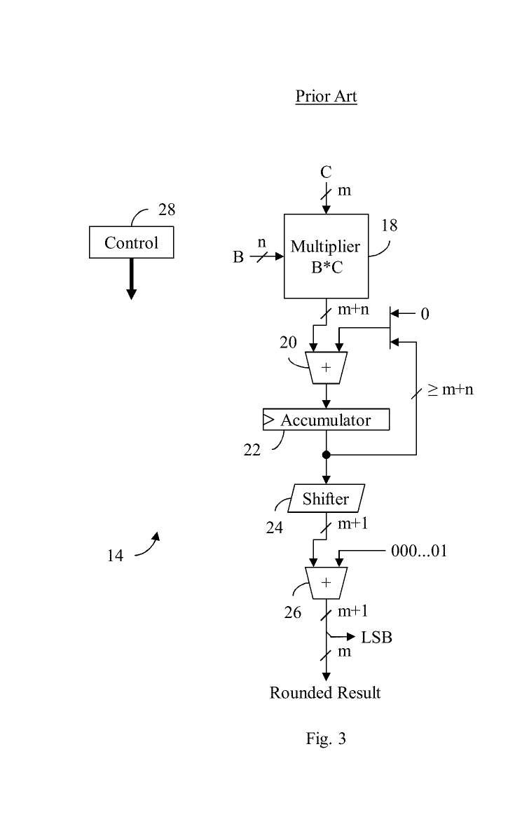

In one other embodiment, my MAC facility 16 may comprise a general purpose DSP, such as is shown in FIG. 2, instantiated within an audio processing system 10, such as is shown in FIG. 1. In such an embodiment, my method may be embodied in a non-transitory computer readable medium including executable instructions which, when executed, causes the processing system 10 to perform the steps of any desired embodiment of my pre-rounding method.

Although I have described my invention in the context of particular embodiments, one of ordinary skill in this art will readily realize that many modifications may be made in such embodiments to adapt either to specific implementations. Thus it is apparent that I have provided a pre-rounding method and apparatus that are both effective and efficient. Further, I submit that my method and apparatus provide performance generally superior to the best prior art techniques.

What I claim is:

1. A rounding method for use in a multiply-accumulate (“MAC”) facility comprising controlling the MAC to perform the steps of:
1.1 developing a product by multiplying a selected multiplicand by a selected multiplier;
1.2 developing a rounded product by adding to the product a selected one of a predetermined rounding value and an accumulator value;
1.3 developing the accumulator value by storing the rounded product; and
1.4 developing a rounded result by selectively shifting the accumulator value.

2. The method of claim 1 wherein step 1.2 is further characterized as comprising the steps of:
1.2.1 during a first cycle, developing the rounded product by adding a predetermined rounding value; and
1.2.2 during a subsequent, second cycle, developing the rounded product by adding the accumulator value.

3. The method of claim 1 wherein step 1.2 is further characterized as comprising the steps of:
1.2.1 during a selected first one of a plurality of cycles, developing the rounded product by adding a predetermined rounding value; and
1.2.2 during a selected second one of the plurality of cycles, developing the rounded product by adding the accumulator value.

4. The method of claim 1 wherein step 1.4 is further characterized as:
1.4 developing a rounded result by selectively shifting and truncating the accumulator value.

5. The method of claim 1:
wherein the product, rounded product and accumulator value are each developed in carry-save format; and
wherein the rounded result is developed in carry-propagated format.

6. A multiply-accumulate facility configured to perform the method of any of the claims 1 to 5.

7. A digital signal processing system comprising a multiply-accumulate facility according to claim 6.

8. A non-transitory computer readable medium including executable instructions which, when executed in a processing system, causes the processing system to perform the steps of a method according to any one of claims 1 to 5.
